(19) United States
(12) Patent Application Publication
(10) Pub. No.: US 2013/0115393 A1
(43) Pub. Date: May 9, 2013

(54) TEXTILE ARTICLES INCORPORATING HIGH PERFORMANCE COMPOSITE FABRIC

(71) Applicant: Jason R. Beck, Peoria, AZ (US)

(72) Inventor: Jason R. Beck, Peoria, AZ (US)

(73) Assignee: Armorworks Enterprises, LLC, Chandler, AZ (US)

(21) Appl. No.: 13/235,744

(22) Filed: Sep. 19, 2011

Related U.S. Application Data
(63) Continuation-in-part of application No. 13/161,322, filed on Jun. 15, 2011.
(60) Provisional application No. 61/384,560, filed on Sep. 20, 2010.

(51) Int. Cl. B32B 5/26; B32B 1/02; D04H 3/04; B32B 3/10

(52) U.S. Cl. 428/35.2; 428/196; 28/100

(57) ABSTRACT

Materials and constructions for wear resistant textile articles are disclosed. In one exemplary embodiment a first portion of a textile article is made from a woven synthetic fiber material, and a second portion of the textile article is made from a composite material. The composite material may comprise an outer layer of a woven synthetic fiber material, and a backing layer of a woven high performance fiber fabric.

This application is a continuation in part of prior application Ser. No. 13/161,322, filed Jun. 15, 2011, and claims the benefit of U.S. Provisional Application No. 60/384,560, filed Sep. 20, 2010, the entire contents of which are hereby incorporated by reference.

### TECHNICAL FIELD AND BACKGROUND

The present invention generally relates to wear resistant textile articles such as various tactical equipment, garments, pouches, packs, ballistic vests, and the like, as well as durable fabrics suitable for use in such textile articles.

### BRIEF DESCRIPTION OF THE DRAWINGS

In the accompanying drawings:

FIG. 1 is a perspective view of an exemplary grenade pouch utilizing a composite fabric in accordance with the present disclosure;

FIG. 2 is another perspective view of the grenade pouch of FIG. 1;

FIG. 3 is a perspective view of the grenade pouch of FIG. 1 turned inside out, shown along with a patterned piece of the composite material used in the pouch;

FIG. 4 is a front view of an exemplary general purpose pouch utilizing the composite material of the present disclosure;

FIG. 5 is the general purpose pouch of FIG. 4 viewed from the top with the pouch unzipped and open;

FIG. 6 is a perspective view of the general purpose pouch of FIG. 4 turned inside out, shown along with a patterned piece of the composite material used in the pouch;

FIG. 7 is a front view of another general purpose pouch shown alongside patterned pieces of the composite material used in the front panel of the pouch;

FIG. 8 is a perspective view of an exemplary backpack constructed using the composite fabric in various strategic locations;

FIGS. 9, 10, and 11 are views of the side, back, and front, respectively of the backpack of FIG. 8, with superimposed dashed lines to indicate regions of the backpack utilizing the composite material of the present disclosure;

FIG. 12 is another front view of the backpack of FIG. 8 shown alongside a partially complete front panel portion of the backpack as viewed from the back side;

FIG. 13 is another front view of the partially complete front panel shown overlaying an inner liner panel; and

FIG. 14 illustrates use of the composite material in the shoulder straps of a backpack.

### DESCRIPTION OF THE EMBODIMENTS

The present invention as described hereinafter may be embodied in many different forms and should not be construed as limited to the embodiments set forth. Rather, these embodiments are provided so that this disclosure will be operative, enabling, and complete. Accordingly, the particular arrangements disclosed are meant to be illustrative only and not limiting as to the scope of the invention. Moreover, many embodiments, such as adaptations, variations, modifications, and equivalent arrangements, will be implicitly disclosed by the embodiments described herein and fall within the scope of the present invention.

Although specific terms are employed herein, they are used in a generic and descriptive sense only and not for purposes of limitation. Unless otherwise expressly defined herein, such terms are intended to be given their broad ordinary and customary meaning not inconsistent with that applicable in the relevant industry and without restriction to any specific embodiment hereinafter described. As used herein, the article “a” is intended to include one or more items. Where only one item is intended, the term “one”, “single”, or similar language is used. When used herein to join a list of items, the term “or” denotes at least one of the items, but does not exclude a plurality of items of the list.

For exemplary methods or processes of the invention, the sequence and/or arrangement of steps described herein are illustrative and not restrictive. Accordingly, it should be understood that, although steps of various processes or methods may be described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Additionally, any references to advantages, benefits, unexpected results, or operability of the present invention are not intended as an affirmation that the invention has been previously reduced to practice or that any testing has been performed. Likewise, unless stated otherwise, use of verbs in the past tense (present perfect or preterit) is not intended to indicate or imply that the invention has been previously reduced to practice or that any testing has been performed.

According to one exemplary embodiment, a lightweight tactical material comprises a composite of a synthetic fabric outer layer combined with a backing layer made from a high strength, damage resistant material. The synthetic outer layer may be for example a durable Nylon-6,6 product presently manufactured by Invista, a wholly owned division of Koch Industries Inc., and sold under the trade name Cordura®. Cordura is used in a wide range of products from luggage and backpacks to boots, military apparel (such as tactical blade sheaths and ammunition pouches), and performance apparel. The weight of an outer layer fabric used in a composite material in accordance with the present disclosure may for example be within a range of about 200 to 1000 denier depending upon the application, and in one particular embodiment about 500 denier.

The backing of the composite material may be made of so-called high performance fibers, such as aramid and other high tenacity fiber materials. Due to their remarkably high tensile strength-to-weight ratio, such high performance fibers have many applications, including for example bicycle tires, racing sails, mooring lines, and body armor. Specific high performance, high tenacity fibers suitable for the composite material of the present invention include but are not limited to Kevlar®, a para-aramid synthetic fiber manufactured by DuPont™; Twaron, another para-aramid fiber with roughly the same chemical structure, manufactured by Teijin Aramid; terephthaloyl chloride (TCI), an aramid fiber closely related to para-aramids, also manufactured by Teijin Aramid and sold under the name Technora®; and high molecular weight polyethylene (HMWPE) such as commercially known Spectra®. Other suitable materials include polybenzobisoxazole fibers (PBO) sold under the name ZYLON™ by Toyobo Co. Ltd., of Osaka, Japan, and heat resistant aramid fiber products such as Dupont's Nomex® and Protera® fabrics. Such fibers may have a tensile strength greater than about 2000 MPa (or greater than about 7 grams per denier) and an elastic modulus greater than about 60 GPa. Moreover, there have been generations of fibers and fabrics made from these fibers which have evolved over the years beginning with the first generation of ballistic nylon; second generation of Kevlar® 29, Kevlar® 49, Twaron and Spectra®; third generation of Twaron T-2000 Microfilament, Kevlar® 129 and Kevlar® LT fabrics; and fourth generation of Araflex™.

In one exemplary embodiment of a backing layer, high performance polymer fibers are utilized in the form of a woven fabric, including for example woven fabrics generally used for repelling and trapping hand driven sharp objects such as knives, awls, shanks and the like. Depending upon the particular intended use, an exemplary woven fabric may be constructed from yarn of anywhere between about 100 and 1200 denier, and aerial densities in the range of 3 to 10 ounces per square yard (“OSY”). For example, fabrics constructed of yarns in the 200 to 300 denier range, and aerial densities in the 3 to 4 OSY range are generally preferred for items such as pouches, small duffels, backpacks and the like. Alternatively for heavier applications such as large suitcases or equipment bags, larger yarns in the 700 to 1200 denier range, and densities in the 7 to 10 OSY range may be preferable.

The woven fabric of the backing layer may be formed of a relatively tight, puncture resistant weave, comprising for example at least 40 fibers per inch in a first, or warp direction, and at least 40 fibers per inch in a second, or fill direction. In one particular embodiment the backing layer comprises a weave with between 60 and 72 fibers per inch in both the warp and fill directions. In addition, the fabric may be formed by tightly weaving multi-filament yarns to obtain a warp yarn “density” or “cover” in excess of 100 percent at the center of the fill yarn, and a fill yarn density or cover in excess of 75 percent as measured between two warp ends. Such tight weaves may comprise in excess of 100 fibers per inch in the warp and fill directions, and filament crossovers in the range of about 50,000,000 (fifty million) filament crossovers per square inch up to 90,000,000 (ninety million) filament crossovers per square inch. An exemplary tightly woven, puncture resistant fabric suitable for a backing layer is disclosed in U.S. Pat. No. 5,565,264, the entire contents of which are hereby incorporated by reference.

In one particularly embodiment, the backing layer is Dupont™ Kevlar® Correctional™, a tightly woven Kevlar® fabric. Kevlar Correctional is advertized as an extremely tight weave utilizing filaments one fourth the size of comparable materials. Another suitable commercially available material is a woven puncture resistant product sold under the trademark TURTLESKIN by Warwick Mills, Inc., of New Ipswich, N.H. These products are available in various weights, with 200 and 300 denier sizes particularly preferred for construction of lightweight personal gear such as packs and pouches, and fabric weights in the 500 to 1000 denier range preferable for larger, heavier articles such as large suitcases and equipment duffels.

The nylon outer material and backing layer are preferably consolidated, or laminated into a unitary composite fabric using any suitable technique such as bonding, stitching, and the like. Suitable bonding methods include for example the use of various types of adhesives, such as air-drying adhesives, chemically setting adhesives, radiation activated adhesives such as UV activated dental adhesives, hot-melt adhesives, and pressure sensitive adhesives. An adhesive may be pre-applied on at least one of the surfaces or materials to be joined, or separately introduced during a lamination process. In one embodiment, two or more fabrics layers are laminated under heat and pressure using a solid, polymer based thermoplastic adhesive, such as a polyamide, polyester, elastomeric urethane, or polyolefin polymer. One particular suitable product is a dry, non-woven mat, or web of a polymer-based thermoplastic manufactured by Spunfab Adhesive Fabrics of Cuyahoga Falls, Ohio. Another suitable material is a class of thermoplastic adhesives by 3M sold under the name “Stitchless Bonding Films”. The fabric layers and the thermoplastic adhesive may be supplied from respective adjacent spools, and fed through a laminating machine with the thermoplastic web sandwiched between the fabric layers. An exemplary hot melt laminating process is described for example in U.S. Pat. No. 5,547,536, the entire contents of which are hereby incorporated by reference.

As noted above, the two fabrics of the present invention may also be consolidated using various types of Pressure Sensitive Adhesives, also referred to as “PSA”s. PSAs are distinguished from most other types of adhesives in that they bond on contact, rather than through a solidifying process such as evaporation, chemical reaction, or melting. PSAs are usually based on an elastomer compounded with a suitable tackifier (e.g., a rosin ester). Suitable elastomers include those based on natural rubber, Nitriles, Butyl rubber, Acrylics, Styrene block copolymers, vinyl ethers, Ethylene-vinyl acetate, and various silicon rubbers. In one exemplary embodiment the PSA comprises an acrylic adhesive such as 3M's family of VHB™ permanent assembly tapes. Another suitable PSA is 3M adhesive# 9485PC, an acrylic sheet approximately 5 mils thick, and sold in rolls up to 48 inches wide.

The strength of the high performance fiber backing makes the composite material particularly beneficial in high wear areas of garments or equipment. Examples of high wear areas include corners of ammunition pouches, fragmentation pouches, radio communication pouches, and armor pockets in armor plate carriers. In ballistic vests and ballistic armor carriers the combination of materials also increases longevity and strength of the key load carriage points, particularly once the material is sewn through. Seams can be further strengthened by folding the seam over to double or triple thickness prior to stitching. In addition, any tears or de-laminations in the outer layer can be temporarily field repaired by re-attaching the damaged outer fabric to the intact backing using a fast setting adhesive such as Cyanoacrylate (referred to generically as “Superglue”) liquid adhesive. Alternatively, if portions of the outer layer are missing or worn away making re-attachment impractical, the intact backing can instead simply be left exposed, and if desired, temporarily disguised using a suitably colored paint or ink marker.

Although the composite fabric has been described primarily in terms of an outer layer and a backing layer, the fabric may comprise additional or different layers. For example, the composite fabric may comprise two or more outer layers, or two or more backing layers, or multiple layers of each. In addition, the layers may be arranged in various configurations, such as two backing layers on one side of a single outer layer, or a sandwich configuration with an outer layer on either side of one or more backing layers. The composite fabric may also be combined with various other material layers, such as a liner made of a breathable or insulative type of fabric or material. The additional materials may be consolidated or attached to an outer layer or backing layer using any of the above described methods and materials. Further, various other combinations of layers and materials are certainly possible, and intended to fall within the scope of the high performance composite fabric of the present disclosure.

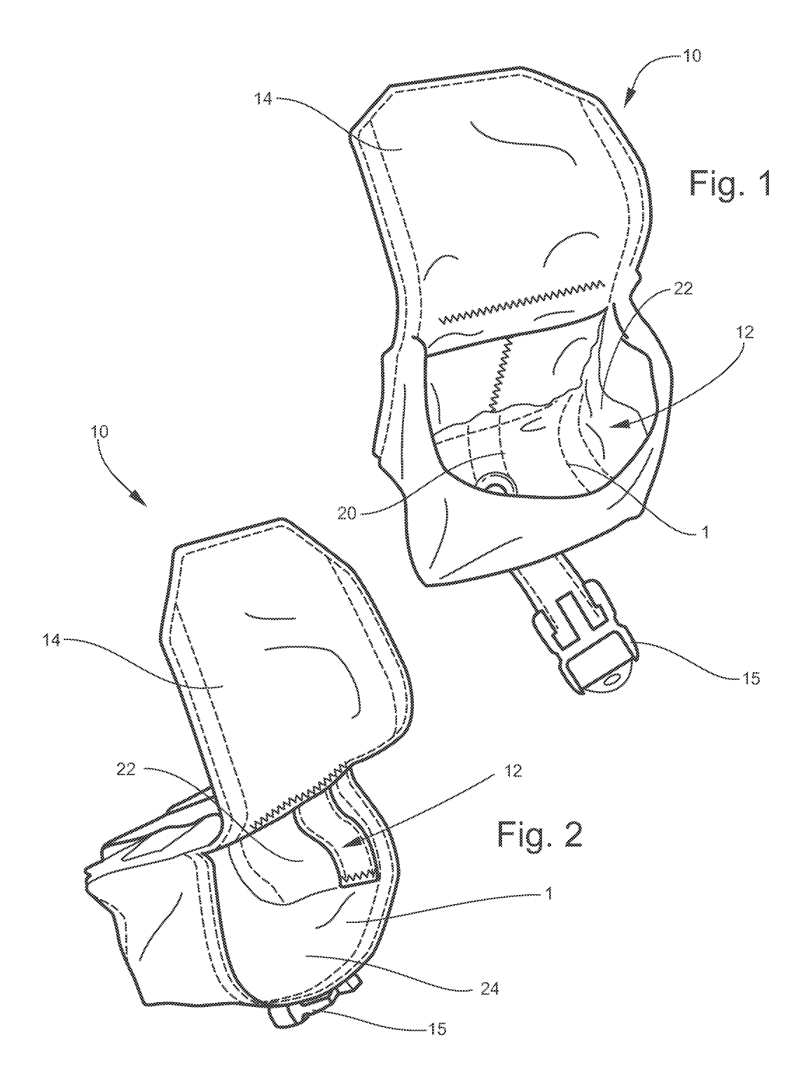

The composite material of the present invention may be utilized in the construction of various types of wear resistant and ruggedized textile articles and containers, particularly tactical gear such as pouches, belts, vests, backpacks, and the like made for military application. For example, FIGS. 1 through 3 depict an exemplary grenade pouch 10 constructed using the composite fabric of the present disclosure. A grenade pouch of the type shown is designed for carrying one hand grenade, and would typically be attached to the outside of a belt or vest. The grenade pouch 10 comprises a single cavity 12 with a flap cover 14 that extends over the top of the cavity and latches to a clip 15 on the front of the pouch to retain the contents. Preferably the front, sides, and bottom of the grenade pouch 10 comprise the composite tactical material 1 of the present disclosure.

As noted above, pouches designed for carrying hard, heavy, rough articles, like hand grenades and ammunition magazines, are particularly susceptible to wear and rub-through in the portions of the pouch exposed to abrasive contact with the environment. In a grenade pouch for example, this would typically be the bottom, sides, and front of the pouch. By contrast the back and top of a typical grenade pouch would be subject to significantly less pressure and abrasion, and thus much less susceptible to wear and rub through. Accordingly in the exemplary grenade pouch of FIG. 1, the composite tactical material is utilized only in those areas prone to excessive wear and rub-through, and not in the other portions of the pouch. In particular, the high performance fiber backing of the material 1 can be seen on the inside the pouch on the bottom 20 and one side 22 in FIG. 1; and on the inside of the front 24 in FIG. 2.

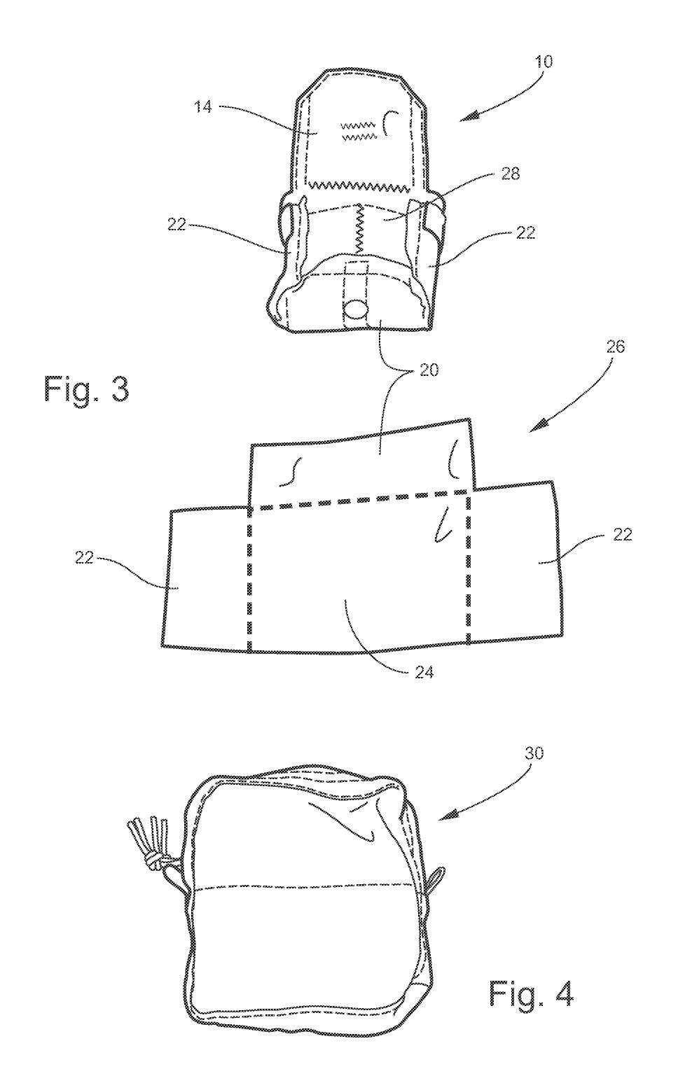

FIG. 3 depicts the pouch 10 turned inside-out as viewed from the back of the pouch, exposing the backing side of composite material 1 on the sides 22 and bottom 24 of the pouch 10. The sides, front, and bottom of the pouch 10 may be fabricated from a single patterned piece 26 of the composite material 1 also shown in FIG. 3, adjacent the pouch 10. Dashed lines are superimposed on patterned piece 26 to indicate where piece 26 would be folded prior to stitching the seams. In this embodiment the back panel 28 and top flap 14 may be fabricated from one single or double layer of relatively light weight tactical nylon such as Cordura.

FIGS. 4 through 6 depict a general purpose pouch 30 constructed using the composite material of the present invention. The pouch is opened and closed by means of a zipper 33 extending around the top and approximately half way down each side. Pouch 30 may be used for carrying a variety of useful articles, many of which are typically relatively hard, sharp, or heavy, and thus likely to cause wear and abrasion of the pouch material. Examples of pouch contents include items such as ammunition magazines or boxes, radios, batteries, flashlights, tools, and the like. The pouch 30 is typically worn on the outside of a belt, vest, or pack, and thus generally exposed to wear and abrasion in the field, particularly when used in a combat environment.

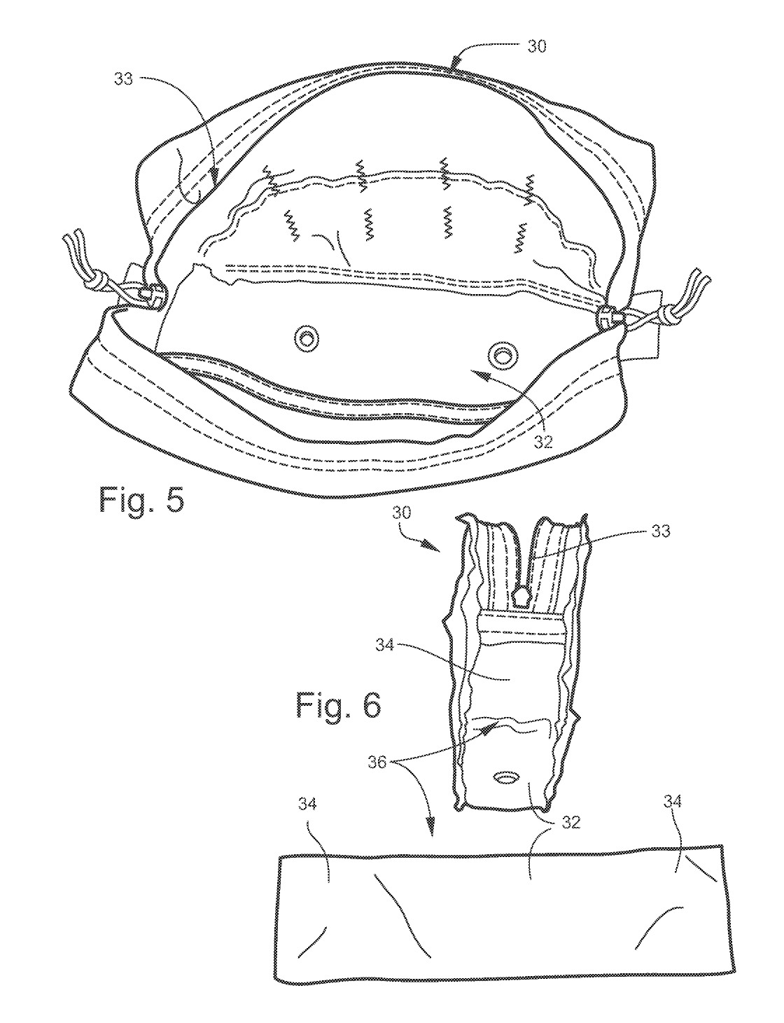

In FIG. 5 the pouch 30 is shown open as viewed from the top, with the composite material of the present invention visible in the bottom 32. The bottom of the pouch and the sides of the pouch below the ends of the zipper are made of the composite material of the present invention. FIG. 6 shows the pouch 30 turned inside out, with the composite material visibly extending from the bottom 32 and up the side 34, terminating below the end of the zipper 33. As depicted, the sides 34 and bottom 32 of the pouch may be comprised of one strip 36 of the composite material, thereby minimizing the number of corners with stitched seams in high wear areas. Although not shown, a general purpose pouch of the type depicted may further comprise the composite material of the present invention in the front and back panels in addition to the bottom and sides. In that case all of the composite material portions of the pouch may comprise a single patterned panel in the manner of piece 26 of FIG. 3.

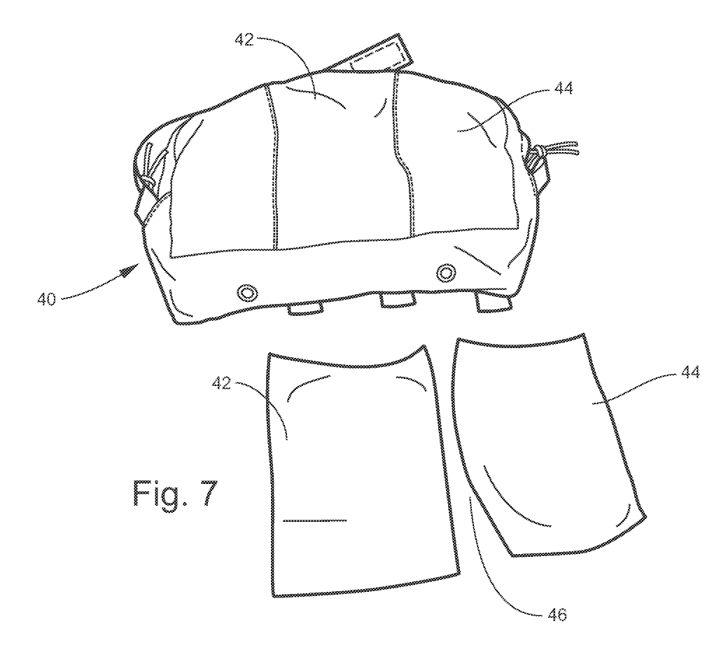

FIG. 7 shows another exemplary general purpose pouch 40 constructed using the composite material in the front panel of the pouch in addition to the bottom and sides. In this particular embodiment the pouch 40 comprises a multiple piece construction of the front panel to create a contoured shape that increases the volume capacity of the pouch. Specifically, the front panel is comprised of a rectangular center piece 42 stitched to curved inner edges 46 of side pieces 44 (only one shown). As previously mentioned, the seams joining the pieces forming the front panel are preferably stitched, folded over, and then double stitched from the outside as reinforcement. If desired the back panel of pouch 40 may also be made of the composite material 1, and constructed using a similar or identical contoured multiple panel design with reinforced seams.

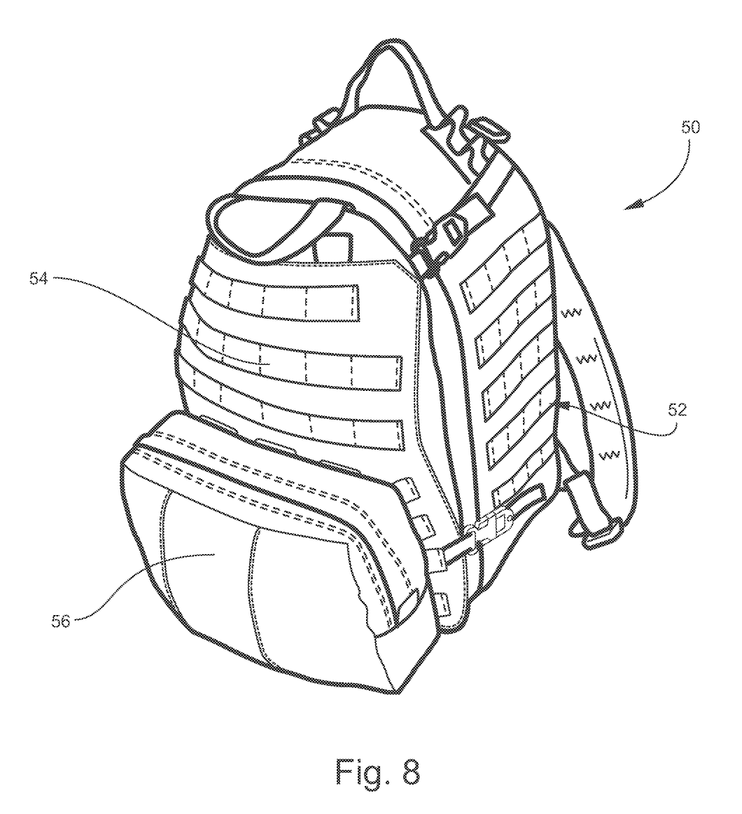

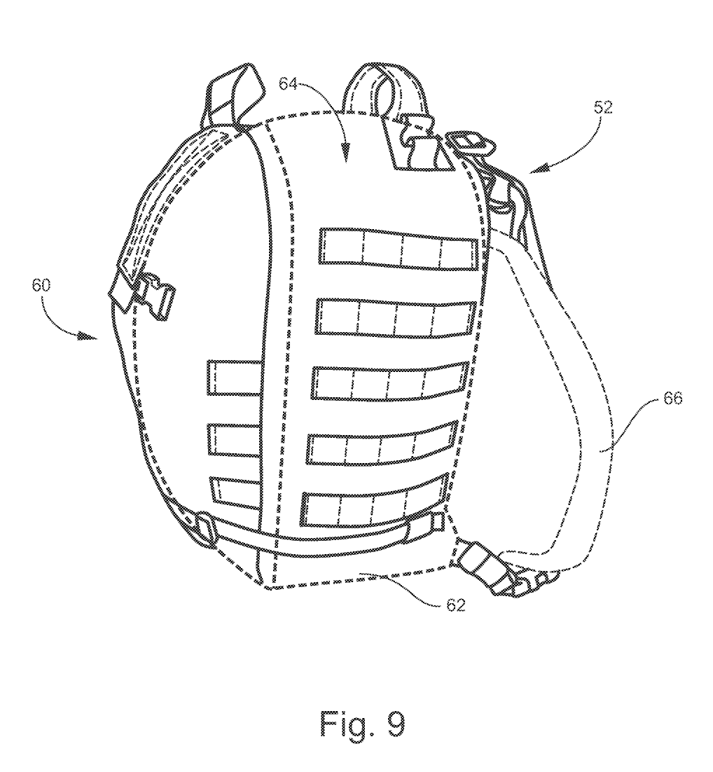

FIGS. 8 through 14 illustrate an exemplary backpack employing the laminated composite material of the present invention in strategic areas. Referring initially to FIG. 8, a tactical style backpack 52 is shown with a releasable external pouch 54 clipped to the front (the side opposite the side with carrying straps) of the backpack 52, and a general purpose pouch 56 similar to previously described pouch 40 attached to the outside of external pouch 54. FIGS. 9 through 11 show backpack 52 again, but without the external pouch 54 and general purpose pouch 56 shown in FIG. 8. Also, superimposed on FIGS. 9 through 11 are dashed lines indicating regions of the backpack constructed with the laminated composite material. Specifically, the composite material is used in the front panel 60, the sides 64, the bottom 62, and the shoulder straps 66. The composite material used in the backpack 52 may be made of the same backing and outer material layers, and consolidated using the same processes as previously described.

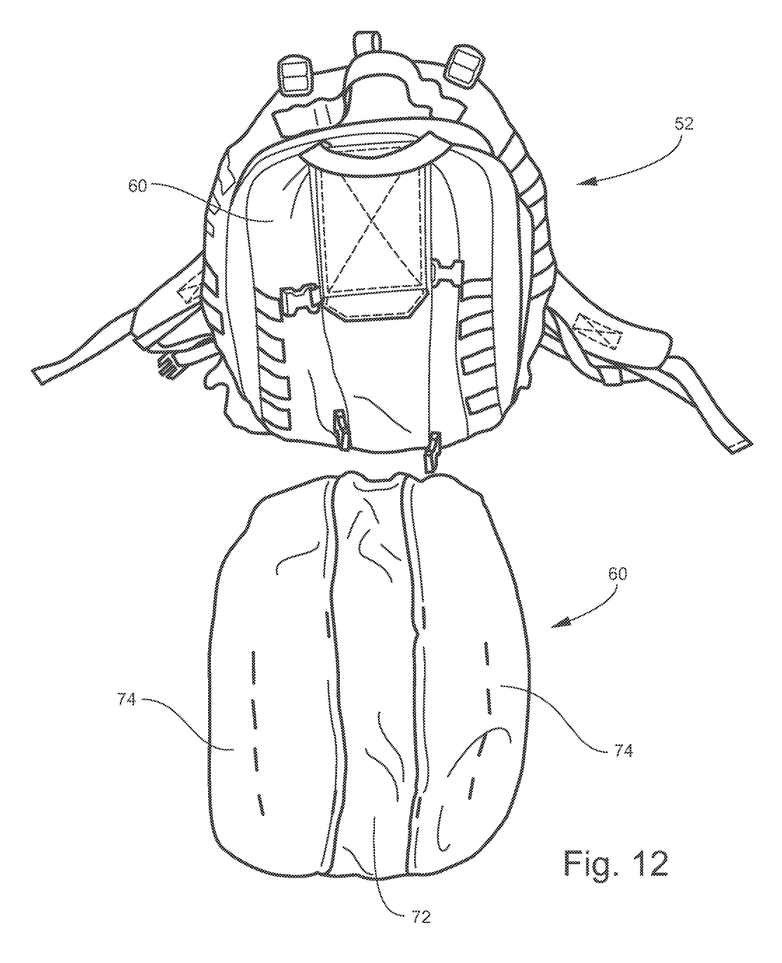

In FIG. 12, backpack 52 is shown next to a partially completed front panel 60 turned over to show the inside. The construction of front panel 60 is similar in one respect to that of previously described general purpose pouch 40, comprising a rectangular center piece 72 stitched to convexly curved edges of side pieces 74, giving panel 60 a three-dimensional, expandable contour. In the particular front panel embodiment shown, center piece 72 is constructed from two or more overlapping layers of tactical nylon, while only the side pieces 74 comprise the composite material of the present invention. The seams between the center and outer pieces 72, 74 may again be folded over and double stitched from the outside to improve strength. Referring to FIG. 13, the front panel 60 may further include an inner liner 76 covering the seams and the backing side of the composite material portions of the panel. Construction of the bottom 62 and sides 64 of the backpack 52 likewise may utilize the composite material as the primary structural element, with a suitable liner or additional constructions defining the interior.

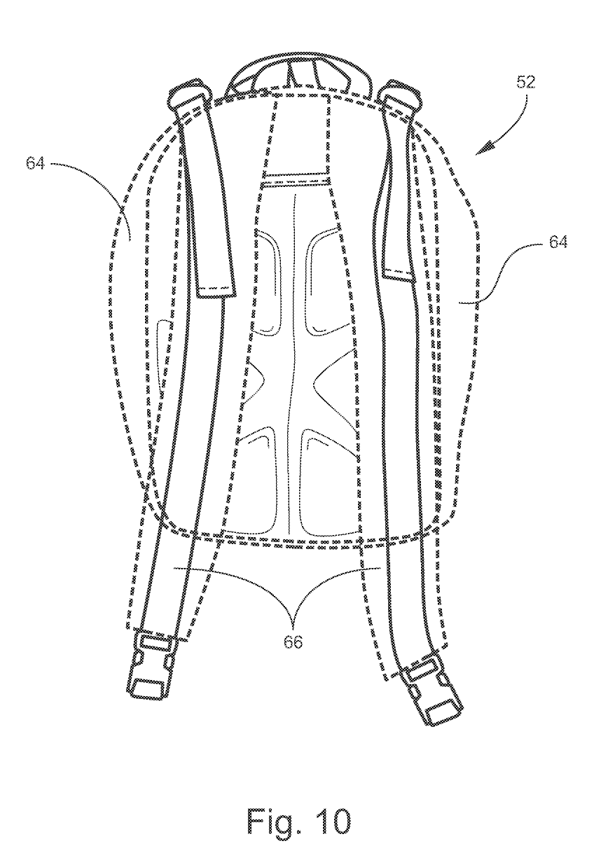

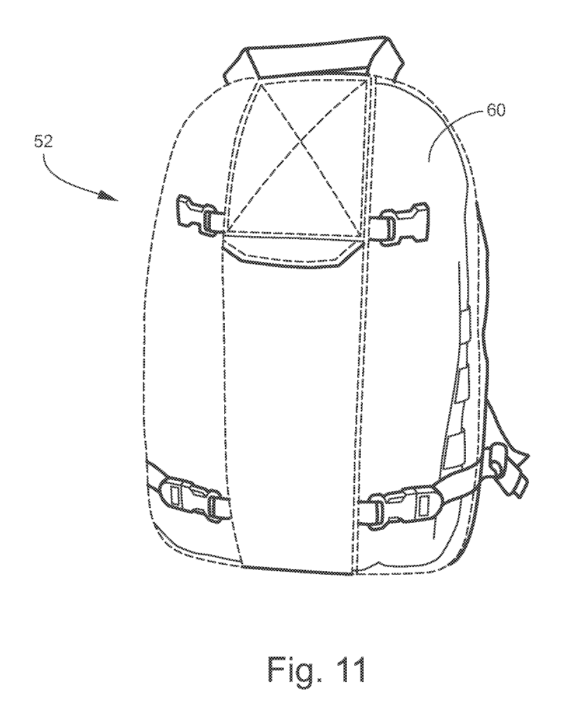

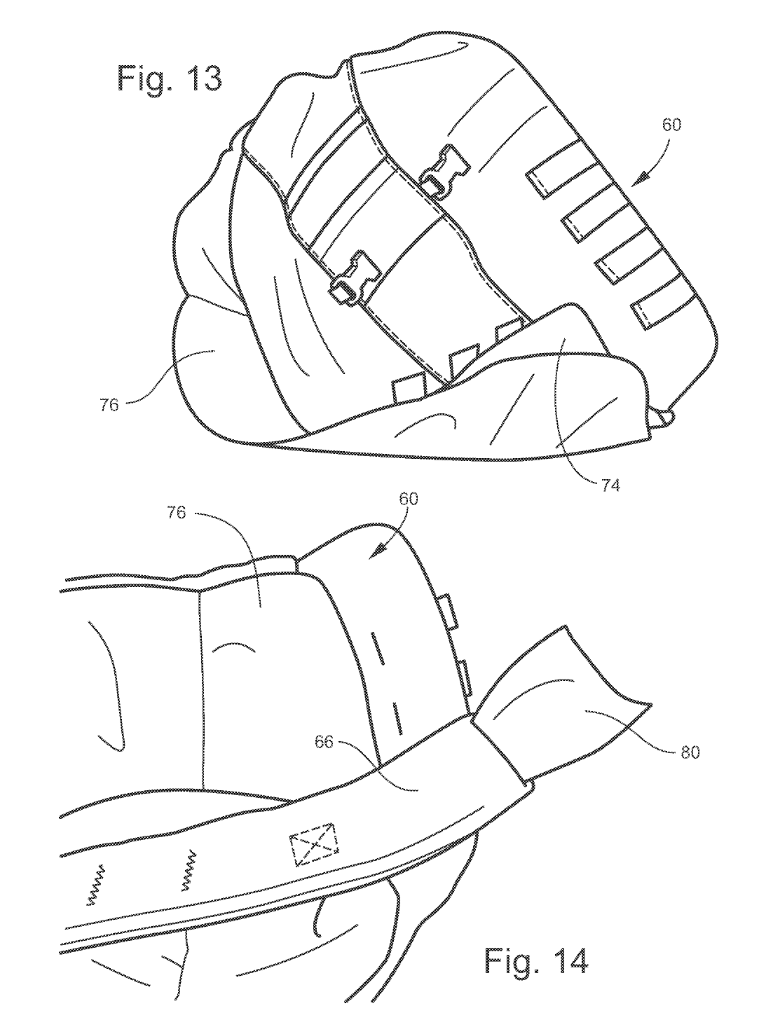

The composite material of the present invention may be further utilized as a convenient reinforcement means at load carriage points and other high stress locations in pouches and packs. For example, a particularly high stress location of any backpack is on the shoulder strap where it attaches to the top of the pack. As illustrated in FIGS. 10 and 14, the composite material may be incorporated in shoulder straps 66, taking advantage of the high tenacity of the high performance fiber backing. In one embodiment, an exemplary shoulder strap 66 incorporates a continuous longitudinal strip of the composite material that is substantially longer than the shoulder strap 66. The strip of composite material may be incorporated such that the excess provides a tab 80 that extends well beyond the upper end of the strap 66. Tab 80 may then be anchored internally to the body of the backpack, thus providing a durable connection without the additional weight and complexity associated with conventional reinforcement techniques.

For the purposes of describing and defining the present invention it is noted that the use of relative terms, such as “substantially”, “generally”, “approximately”, and the like, are utilized herein to represent an inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

Exemplary embodiments of the present invention are described above. No element, act, or instruction used in this description should be construed as important, necessary, critical, or essential to the invention unless explicitly described as such. Although only a few of the exemplary embodiments have been described in detail herein, those skilled in the art will readily appreciate that many modifications are possible in these exemplary embodiments without materially departing from the novel teachings and advantages of this invention. Accordingly, all such modifications are intended to be included within the scope of this invention as defined in the appended claims.

In the claims, any means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Unless the exact language “means for” (performing a particular function or step) is recited in the claims, a construction under §112, 6th paragraph is not intended. Additionally, it is not intended that the scope of patent protection afforded the present invention be defined by reading into any claim a limitation found herein that does not explicitly appear in the claim itself.

What is claimed is:

1. A wear resistant textile article, comprising:
a first portion of the textile article made from a woven synthetic fiber material;
a second portion of the textile article made from a composite material comprising an outer layer of a woven synthetic fiber material, and a backing layer of a woven high performance fiber fabric.

2. The wear resistant textile article of claim 1, wherein the article is a closeable container selected from the group comprising pouches and backpacks.

3. The wear resistant textile article of claim 2, wherein the first portion of the textile article is a first panel of the container, and the second portion of the article is a second panel of the container sharing a stitched seam with the first panel.

4. The wear resistant textile article of claim 3, wherein the second panel is a bottom panel of the container.

5. The wear resistant textile article of claim 3, wherein the seam is folded over and double stitched from the outside of the pouch.

6. The wear resistant textile article of claim 1, wherein the outer layer of the composite material is made of nylon.

7. The wear resistant textile article of claim 1, wherein the backing layer of the composite material is made of high performance polymer fibers.

8. The wear resistant textile article of claim 7, wherein the high performance polymer fibers are selected from the group comprising aramid fibers, para-aramid fibers, high molecular weight polyethylene fibers, polybenzobisoxazole fibers, and terephthaloyl chloride fibers.

9. The wear resistant textile article of claim 7, wherein the backing layer is formed of a puncture resistant, relatively tight weave, comprising at least 60 fibers per inch in a first, warp direction, and at least 60 fibers per inch in a second, fill direction.

10. The wear resistant textile article of claim 9, wherein the puncture resistant backing layer is characterized by a warp yarn density in excess of 100 percent, and a fill yarn density in excess of 75 percent.

11. The wear resistant textile article of claim 1, wherein the backing layer of the composite material is consolidated with the outer layer through a laminating process using a thermoset adhesive.

12. The wear resistant textile article of claim 1, wherein the backing layer of the composite material is Kevlar® Correctional™ para-aramid fiber fabric.

13. A lightweight, wear resistant textile article, comprising:
a first portion of the textile article made from a woven durable fiber material;
a second portion of the textile article made from a composite material comprising an outer layer of a woven durable fiber material, and a backing layer of a woven high tenacity fiber fabric.

14. The lightweight, wear resistant textile article of claim 13, wherein the second portion of the textile article is exposed to more wear or abrasion in use than the first portion.

15. The lightweight, wear resistant textile article of claim 13, wherein the article is a closeable container selected from the group comprising pouches and backpacks.

16. The wear resistant textile article of claim 13, wherein the first portion of the textile article is a first panel of the container, and the second portion of the article is a second panel of the container sharing a stitched seam with the first panel.

17. The wear resistant textile article of claim 13, wherein the high tenacity fibers of the composite material backing layer are high performance polymer fibers.

18. The wear resistant textile article of claim 17, wherein the high performance polymer fibers of the backing layer are in a puncture resistant, relatively tight weave, comprising at least 60 fibers per inch in a first, warp direction, and at least 60 fibers per inch in a second, fill direction.

19. A method of minimizing total weight of a textile article designed for a high wear environment, comprising:
fabricating a first portion of the textile article from a woven durable fiber material; and
using a composite material comprising an outer layer of a durable woven material, and a backing layer of a woven high tenacity fiber material in a second portion of the textile article, wherein the second portion of the textile article is exposed to substantially more wear than the first portion.

20. The method of claim 19, wherein the woven high tenacity fiber material of the backing layer is in a puncture resistant, relatively tight weave, comprising at least 60 fibers per inch in a first, warp direction, and at least 60 fibers per inch in a second, fill direction.
